(19) United States
(12) Patent Application Publication
(10) Pub. No.: US 2021/0034740 A1
(43) Pub. Date: Feb. 4, 2021

(54) THREAT ANALYSIS SYSTEM, THREAT ANALYSIS METHOD, AND THREAT ANALYSIS PROGRAM

(71) Applicant: NEC CORPORATION, Tokyo (JP)

(72) Inventors: Yohei SUGIYAMA, Tokyo (JP); Yoshio YANAGISAWA, Tokyo (JP); Hirokazu KAGO, Tokyo (JP)

(73) Assignee: NEC CORPORATION, Tokyo (JP)

(21) Appl. No.: 16/982,331

(22) PCT Filed: Sep. 12, 2018
(86) PCT No.: PCT/JP2018/033786

§ 371 Date: Sep. 18, 2020

(30) Foreign Application Priority Data
Mar. 19, 2018 (JP) 2018-050503

(51) Int. Cl. G06F 21/55; G06N 20/00

(52) U.S. Cl. CPC G06F 21/552; G06F 2221/034; G06N 20/00

(57) ABSTRACT

A threat detection unit 81 detects a log likely to represent a threat from among acquired logs. A flagging processing unit 82 generates flagged data obtained by flagging the detected log based on a flag condition that defines a flag to be set according to a condition that the log satisfies. A determination unit 83 applies the flagged data to a model in which the flag is set as an explanatory variable and whether to represent a threat or not is set as an objective variable to determine whether the log as a source with the flagged data generated therefrom is a log representing a threat or not. An output unit 84 outputs the determination result indicative of whether the log is a log representing a threat or not.

### TECHNICAL FIELD

The present invention relates to a threat analysis system, a threat analysis method, and a threat analysis program for analyzing a threat from collected logs.

### BACKGROUND ART

With the recent expansion of cyberattacks, the demand for SOC (Security Operation Center)/CSIRT (Computer Security Incident Response Team) has been increasing. Specifically, the SOC/CSIRT conducts the analysis of and countermeasures against a threat based on advanced knowledge in SIEM (Security Information and Event Management) analysis business.

Further, various methods of detecting a threat are proposed. For example, Patent Literature 1 (PTL1) discloses an attack analysis system in which an attack detection system and a log analysis system cooperate with each other to perform an attack analysis efficiently. The system disclosed in PTL1 executes a correlation analysis in real time from collected logs based on a detection rule. When an attack corresponding to the detection rule is detected, the system disclosed in PTL1 searches a database for an attack expected to occur next, calculates the time at which the attack is expected to occur, and makes a scheduled search for a log at the expected time.

### CITATION LIST

### Patent Literature

PTL 1: WO 2014/112185

### SUMMARY OF INVENTION

### Technical Problem

Meanwhile, it is generally difficult to detect all threats merely by using the detection rule as described in PTL 1. Therefore, even information thus detected is generally checked manually in order to improve the accuracy of detecting threats. However, the number of logs to be checked is generally large and there are a wide variety of formats of logs. Therefore, when logs likely to be threats are investigated directly, the possibility of false negatives increases. There is also a problem that the accuracy depends on the individual expert. Further, since advanced knowledge is required to detect a threat, there is a problem of the lack of security monitoring specialists, and hence an increase in operational burden.

Therefore, it is an object of the present invention to provide a threat analysis system, a threat analysis method, and a threat analysis program capable of improving the accuracy of detecting threats while reducing the operational burden of security monitoring specialists.

### Solution to Problem

A threat analysis system according to the present invention includes: a threat detection unit which detects a log likely to represent a threat from among acquired logs, a flagging processing unit which generates flagged data obtained by flagging the detected log based on a flag condition that defines a flag to be set according to a condition that the log satisfies; a determination unit which applies the flagged data to a model in which the flag is set as an explanatory variable and whether to represent a threat or not is set as an objective variable to determine whether the log as a source with the flagged data generated therefrom is a log representing a threat or not; and an output unit which outputs the determination result indicative of whether the log is a log representing a threat or not.

A threat analysis method according to the present invention includes: detecting a log likely to represent a threat from among acquired logs; generating flagged data obtained by flagging the detected log based on a flag condition that defines a flag to be set according to a condition that the log satisfies; applying the flagged data to a model in which the flag is set as an explanatory variable and whether to represent a threat or not is set as an objective variable to determine whether the log as a source with the flagged data generated therefrom is a log representing a threat or not; and outputting the determination result indicative of whether the log is a log representing a threat or not.

A threat analysis program according to the present invention causes a computer to execute: a threat detection process of detecting a log likely to represent a threat from among acquired logs; a flagging process of generating flagged data obtained by flagging the detected log based on a flag condition that defines a flag to be set according to a condition that the log satisfies; a determination process of applying the flagged data to a model in which the flag is set as an explanatory variable and whether to represent a threat or not is set as an objective variable to determine whether the log as a source with the flagged data generated therefrom is a log representing a threat or not; and an output process of outputting the determination result indicative of whether the log is a log representing a threat or not.

### Advantageous Effects of Invention

According to the present invention, the accuracy of detecting threats can be improved while reducing the operational burden of security monitoring specialists.

### BRIEF DESCRIPTION OF DRAWINGS

FIG. 1 is a block diagram illustrating a configuration example of one embodiment of a threat analysis system according to the present invention.

FIG. 2 is an explanatory drawing illustrating an example of logs.

FIG. 3 is an explanatory drawing illustrating an example of flag conditions.

FIG. 4 is an explanatory drawing illustrating an example of processing for generating flagged data.

FIG. 5 is a flowchart illustrating an operation example of the threat analysis system.

FIG. 6 is a block diagram illustrating an outline of a threat analysis system according to the present invention.

### DESCRIPTION OF EMBODIMENT

An embodiment of the present invention will be described below with reference to the accompanying drawings.

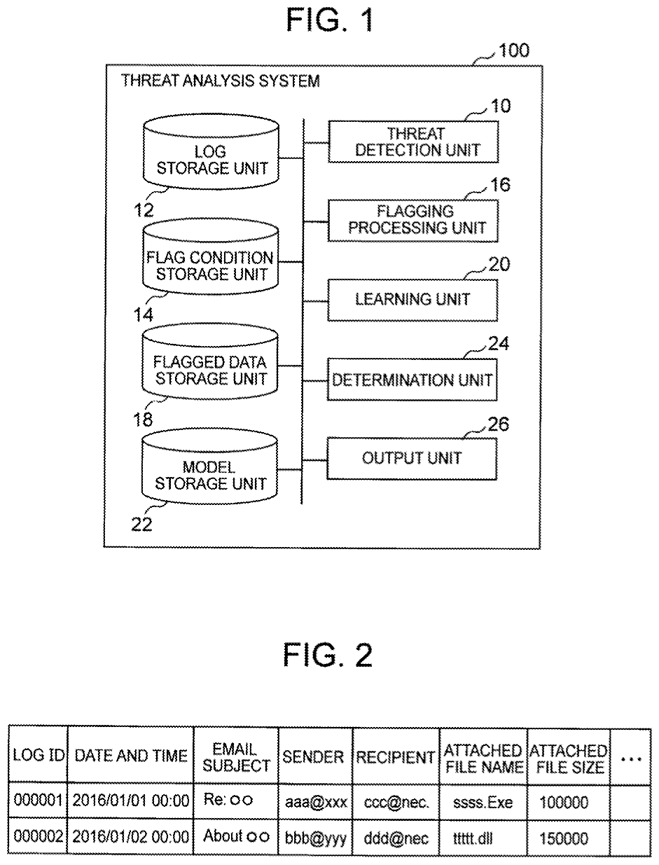

FIG. 1 is a block diagram illustrating a configuration example of one embodiment of a threat analysis system according to the present invention. A threat analysis system 100 of the embodiment includes a threat detection unit 10, a log storage unit 12, a flag condition storage unit 14, a flagging processing unit 16, a flagged data storage unit 18, a learning unit 20, a model storage unit 22, a determination unit 24, and an output unit 26.

The threat detection unit 10 detects a log likely to represent a threat based on a predetermined condition from among logs acquired by devices such as various sensors and servers. The form of the log is optional in the embodiment. Examples of logs include an email log and a web access log.

In the following description, the email log is taken as a specific example. For example, the email log contains a log ID capable of identifying the log, the sending date and time, an email subject, a sender, a recipient, an attached file name, and an attached file size. These contents can also be referred to as character strings contained in specific items (fields) of the log. For example, the “email subject” can also be referred to as a character string contained in a “subject” field of the email log, and the “sender” can also be referred to as a character string contained in a “sender” field of the email log.

A method in which the threat detection unit 10 detects a log likely to represent a threat is also optional, and a commonly known method is used. As the method of detecting the log, there is detection by an email filter or a proxy server, detection by predetermined packet monitoring or a sandbox, or the like. Further, the threat detection unit 10 may also be realized by an email server which detects a threat upon receipt of the email or an active directory (registered trademark) server which detects a threat at the time of authentication. The threat detection unit 10 registers the detected log in the log storage unit 12.

Since the threat analysis system 100 includes the threat detection unit 10, a log likely to represent a threat can be narrowed down from among a large number of logs, and this can reduce the operational burden of a security monitoring specialist.

The log storage unit 12 stores information representing each log. For example, the log storage unit 12 stores each log likely to represent a threat detected by the threat detection unit 10. In addition, the log storage unit 12 may store information (also referred to as a “threat flag”) for identifying whether each log is a log representing a threat or not in association with the log.

FIG. 2 is an explanatory drawing illustrating an example of logs stored in the log storage unit 12. The logs illustrated in FIG. 2 are pieces of email data, each of which indicates that the date and time of receiving each email, the email subject, the sender, and the recipient are associated with a log ID for identifying each piece of email data. Further, as illustrated in FIG. 2, an attached file (attached file name) contained in each log and the file size of the attached file may also be associated with the log.

In FIG. 2, email data is stored in respective fields in a table format, but the form of storing each log is not limited to the table format. For example, the log may be plaintext data or the like as long as the flagging processing unit 16 to be described later can identify the contents of the log.

The flag condition storage unit 14 stores a condition used to flag (1 or 0) each log (hereinafter referred to as a flag condition). Specifically, the flag condition is a condition that defines a flag to be set according to a condition that the log satisfies. The flag condition is defined according to the type of flag to be set, respectively.

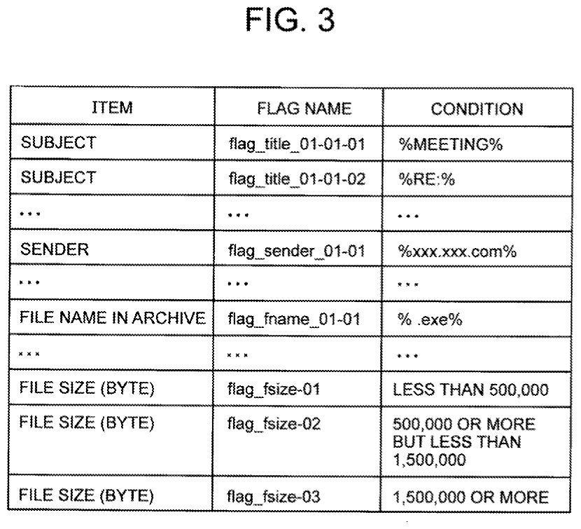

FIG. 3 is an explanatory drawing illustrating an example of conditions stored in the flag condition storage unit 14. In the example illustrated in FIG. 3, a different flag is defined for each condition that each item satisfies. For example, a flag represented by flag name =“flag_title_01-01-01” means to be flagged based on whether a character of “meeting” indicated as a condition is included in a character string of item=“subject” or not. Further, for example, a flag represented by flag name=“flag_sender_01-01” means to be flagged based on whether a character of “xxx.xxx.com” indicated as a condition is included in a character string of item=“sender” or not.

Further, as illustrated in FIG. 3, a flagging condition may be defined based on whether a file having a file name as “.exe” (a blank space before extension exe) is included in an archive or not, or the flagging condition may be defined by the file size.

The flag conditions are predefined by an administrator or the like. It is preferred that flagging conditions should be conditions capable of efficiently learning or determining whether a threat is contained in a target log or not. Therefore, a character string, a file size, and an archive file name contained in each of logs determined to contain threats in the past may be used as flagging conditions.

For example, among character strings contained in the logs determined to represent threats in the past, the flag condition may be a condition that determines whether a character string exceeding a predetermined frequency is contained or not. This is because a log containing a frequent character string is considered likely to represent a threat. Further, for example, the flag condition may be such that a range set as a flag is determined according to a size distribution of logs to be determined. Setting the flag condition according to the distribution can reduce biased flagging.

The flagging processing unit 16 generates data obtained by flagging each log stored in the log storage unit 12 (hereinafter referred to as flagged data) based on the flag condition stored in the flag condition storage unit 14. In other words, based on the flag condition stored in the flag condition storage unit 14, the flagging processing unit 16 generates flagged data obtained by changing a specific character string contained in a log stored in the log storage unit 12 to information (a value; 0 or 1 as a specific example) corresponding to the specific character string. In the following, the description is made in a case where the flagging processing unit 16 generates corresponding information “1” when the specific character string is contained in the log as flagged data, and generates corresponding information “0” when the specific character string is not contained in the log. Note that the content of flagged data is not limited to 0 or 1 as long as the information is identifiable as to whether to satisfy the condition or not. The flagging processing unit 16 registers the generated flagged data in the flagged data storage unit 18.

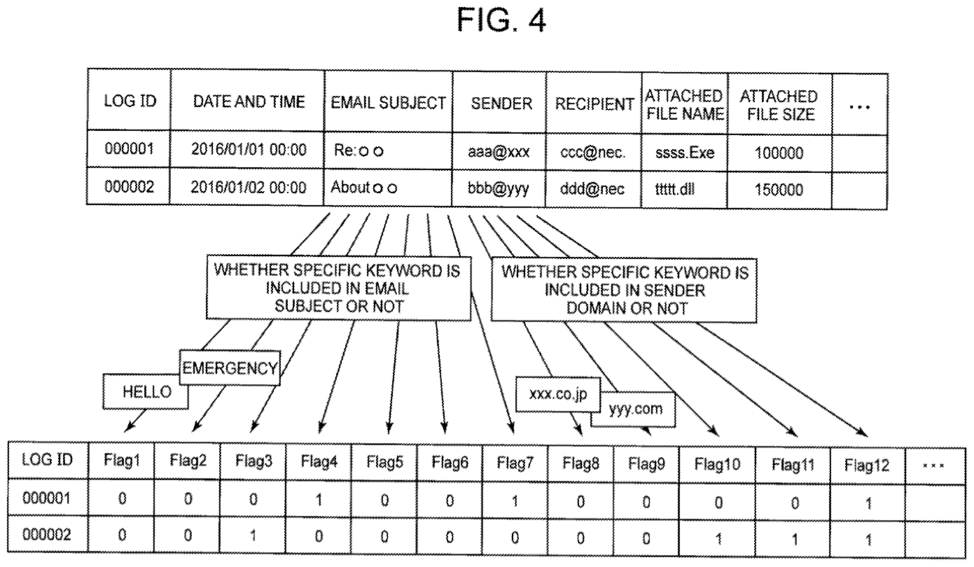

FIG. 4 is an explanatory drawing illustrating an example of processing for generating flagged data. In the example illustrated in FIG. 4, Flag 1 to Flag 7 are values set according to the flag condition indicative of “whether a specific keyword is included in an email subject or not”, and Flag 8 to Flag 12 are values set according to the flag condition indicative of “whether a specific keyword is included in a sender domain or not.”

Further, in the example illustrated in FIG. 4, Flag 1 is a value set according to whether a character string with “hello” is included in the email subject or not, Flag 2 is a value set according to whether a character string with “emergency” is included in the email subject or not. Similarly, Flag 1 is a value set according to whether a character string with “hello” is included in the email subject or not, Flag 8 is a value set according to whether a character string as “xxx.co.jp” is included in the sender domain (sender) or not, and Flag 9 is a value set according to whether a character string as “yyy.com” is included in the sender domain or not.

Further, for example, any free email domain may be set in the sender domain.

For example, in the example illustrated in FIG. 4, the email subject of log data identified by log ID=“000001” is “Re:◯ ◯00”. Namely, neither the character string with “hello” nor the character string with “emergency” is included in the email subject. Therefore, the flagging processing unit 16 generates data obtained by flagging the values of Flag 1 and Flag 2 as “0”, respectively. Further, for example, when this log data satisfies conditions of Flag 4 and Flag 7 defined separately, the flagging processing unit 16 generates data obtained by flagging the values of Flag 4 and Flag 7 as “1”, respectively. The same applies to the sender domain. Thus, since the flagging processing unit 16 flags each character string and uses the flagged information, the learning unit 20 and the determination unit 24 to be described later can not only reduce the processing load but also execute processing more quickly compared with the case of using the character string.

The flagged data storage unit 18 stores flagged data. When the determination unit 24 to be described later directly uses the flagged data generated by the flagging processing unit 16, the threat analysis system 100 may not include the flagged data storage unit 18.

The learning unit 20 learns a model in which each flag described above is set as an explanatory variable and whether to represent a threat or not is set as an objective variable. Specifically, the learning unit 20 uses learning data in which the flagged log is associated with information indicative of whether the log represents a threat or not to learn the model mentioned above. Whether to represent a threat or not may be defined according to the model to be generated. For example, it may be expressed as 0 (no threat) or 1 (there is a threat), or it may be expressed as a degree of threat. The learning data may be created, for example, by the flagging processing unit 16 flagging each log determined as to whether to represent a threat or not in the past. The model learned by the learning unit 20 is referred to as a learned model below.

The model storage unit 22 stores the learned model generated by the learning unit 20.

The determination unit 24 applies flagged data to each learned model to determine whether the log as a source with the flagged data generated therefrom is a log representing a threat or not. For example, when the learned model is a model for determining by 0/1 whether to represent a threat or not, the determination unit 24 may determine, to be a log representing a threat, a log as a source with flagged data generated therefrom and determined to be 1 (there is a threat). Further, for example, when the learned model is a model for calculating, by a degree, as to whether to represent a threat or not, the determination unit 24 may determine, to be a log representing a threat, a log as a source with flagged data generated therefrom and for which a degree exceeding a predefined threshold value is calculated. Note that the method of setting this threshold value is optional. For example, the threshold value may be set based on data determined that there is a threat in the past, or may be set according to the validation result of the learned model.

The output unit 26 outputs the determination result indicative of whether a log to be determined is a log representing a threat or not.

The flag condition storage unit 14, the flagging processing unit 16, the learning unit 20, the determination unit 24, and the output unit 26 are realized by a CPU of a computer operating according to a program (threat analysis program). The threat detection unit 10 may also be realized by the CPU of the computer operating according to the program. For example, the program may be stored in a storage unit (not illustrated) of the threat analysis system 100, and the CPU may read the program and operate as the flag condition storage unit 14, the flagging processing unit 16, the learning unit 20, the determination unit 24, and the output unit 26 according to the program.

The flag condition storage unit 14, the flagging processing unit 16, the learning unit 20, and the output unit 26 may also be realized in dedicated hardware, respectively. Further, for example, the log storage unit 12, the flagged data storage unit 18, and the model storage unit 22 are realized by a magnetic disk or the like.

In the embodiment, the case where the threat analysis system 100 includes the learning unit 20 and the model storage unit 22 is described. However, the learning unit 20 and the model storage unit 22 may be realized by an information processing apparatus (not illustrated) independent of the threat analysis system 100 of this application. In this case, the determination unit 24 may be such that the information processing apparatus mentioned above receives the generated learned model to perform determination processing.

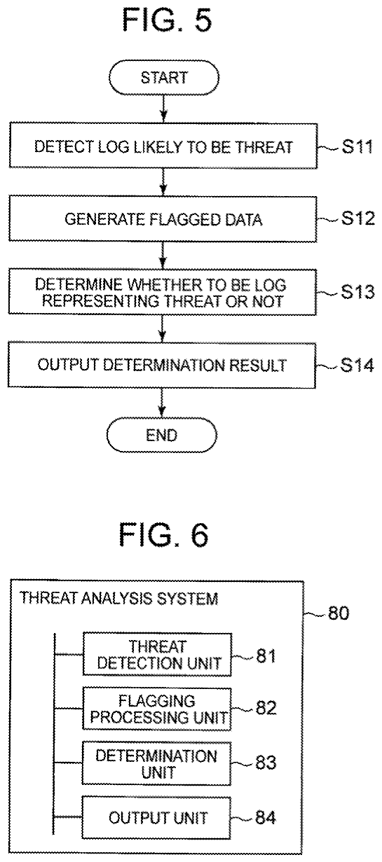

Next, the operation of the threat analysis system 100 of the embodiment will be described. FIG. 5 is a flowchart illustrating an operation example of the threat analysis system 100 of the embodiment.

The threat detection unit 10 detects a log likely to represent a threat from among acquired logs (step S11) and stores the log in the log storage unit 12. The flagging processing unit 16 generates flagged data obtained by flagging the detected log based on a flag condition stored in the flag condition storage unit 14 (step S12). The determination unit 24 applies the flagged data to a learned model generated by the learning unit 20 to determine whether the log as a source with the flagged data generated therefrom is a log representing a threat or not (step S13). Then, the output unit 26 outputs the determination result (step S14).

As described above, in the embodiment, the threat detection unit 10 detects a log likely to represent a threat from among acquired logs, and the flagging processing unit 16 generates flagged data from the detected log based on the flag condition. Then, the determination unit 24 applies the flagged data to a model described above to determine whether the log as a source with the flagged data generated therefrom is a log representing a threat or not, and the output unit 26 outputs the determination result. Thus, the accuracy of detecting threats can be improved while reducing the operational burden of security monitoring specialists.

Next, an outline of the present invention will be described. FIG. 6 is a block diagram illustrating an outline of a threat analysis system according to the present invention. A threat analysis system 80 (for example, the threat analysis system 100) according to the present invention includes: a threat detection unit 81 (for example, the threat detection unit 10) which detects a log likely to represent a threat from among acquired logs; a flagging processing unit 82 (for example, the flagging processing unit 16) which generates flagged data obtained by flagging the detected log based on a flag condition that defines a flag to be set according to a condition that the log satisfies; a determination unit 83 (for example, the determination unit 24) which applies the flagged data to a model in which the flag is set as an explanatory variable and whether to represent a threat or not is set as an objective variable to determine whether the log as a source with the flagged data generated therefrom is a log representing a threat or not; and an output unit 84 (for example, the output unit 26) which outputs the determination result indicative of whether the log is a log representing a threat or not.

According to this configuration, the accuracy of detecting threats can be improved while reducing the operational burden of security monitoring specialists.

Specifically, the threat detection unit 81 may detect an email log likely to represent a threat, and the flagging processing unit 82 may generate flagged data based on a flag condition for determining whether a predetermined character string is included in a sender (for example, the sender domain) of the email or not.

The flag condition may also include a condition used to determine whether a character string exceeding a predetermined frequency is included or not among character strings contained in logs determined to represent threats in the past.

Further, a setting range of a flag may be determined as the flag condition according to a distribution of sizes of logs to be determined.

The threat analysis system 80 may also include a learning unit (for example, the learning unit 20) which learns a model using learning data in which the log as a source with the flagged data generated therefrom is associated with information indicative of whether the log represents a threat or not. Then, the determination unit 83 may apply the flagged data to the model to determine whether the log as a source with the flagged data generated therefrom is a log representing a threat or not.

While the invention of this application has been described with reference to the embodiment and examples, the invention of this application is not limited to the above embodiment and examples. Various changes understandable by those skilled in the art can be made to the configuration and details of the invention of this application within the scope of the invention of this application.

This application claims the priority based on Japanese Patent Application No. 2018-050503, filed on Mar. 19, 2018, the disclosure of which is hereby incorporated herein by reference in its entirety.

### REFERENCE SIGNS LIST

10 threat detection unit

12 log storage unit

14 flag condition storage unit

16 flagging processing unit

18 flagged data storage unit

20 learning unit

22 model storage unit

24 determination unit

26 output unit

1. A threat analysis system comprising a hardware processor configured to execute a software code to:
detect a log likely to represent a threat from among acquired logs;
generate flagged data obtained by flagging the detected log based on a flag condition that defines a flag to be set according to a condition that the log satisfies;
apply the flagged data to a model in which the flag is set as an explanatory variable and whether to represent a threat or not is set as an objective variable to determine whether the log as a source with the flagged data generated therefrom is a log representing a threat or not; and
output a determination result indicative of whether the log is a log representing a threat or not.

2. The threat analysis system according to claim 1, wherein the hardware processor is configured to execute a software code to:
detect an email log likely to represent a threat, and
generate flagged data based on a flag condition for determining whether a predetermined character string is included in a sender of the email or not.

3. The threat analysis system according to claim 1, wherein the flag condition includes a condition used to determine whether or not to include a character string exceeding a predetermined frequency among character strings contained in logs determined to represent threats in the past.

4. The threat analysis system according to claim 1, wherein a setting range of a flag is determined as the flag condition according to a distribution of sizes of logs to be determined.

5. The threat analysis system according to claim 1,
wherein the hardware processor is configured to execute a software code to: learn a model using learning data in which the log as a source with the flagged data generated therefrom is associated with information indicative of whether the log represents a threat or not, and
apply the flagged data to the model to determine whether the log as a source with the flagged data generated therefrom is a log representing a threat or not.

6. A threat analysis method comprising:
detecting a log likely to represent a threat from among acquired logs;
generating flagged data obtained by flagging the detected log based on a flag condition that defines a flag to be set according to a condition that the log satisfies;
applying the flagged data to a model in which the flag is set as an explanatory variable and whether to represent a threat or not is set as an objective variable to determine whether the log as a source with the flagged data generated therefrom is a log representing a threat or not; and
outputting a determination result indicative of whether the log is a log representing a threat or not.

7. The threat analysis method according to claim 6, wherein
an email log likely to represent a threat is detected, and
flagged data is generated based on a flag condition for determining whether a predetermined character string is included in a sender of the email or not.

8. A non-transitory computer readable information recording medium storing a threat analysis program, when executed by a processor, that performs a method for:
detecting a log likely to represent a threat from among acquired logs;
generating flagged data obtained by flagging the detected log based on a flag condition that defines a flag to be set according to a condition that the log satisfies;
applying the flagged data to a model in which the flag is set as an explanatory variable and whether to represent a threat or not is set as an objective variable to determine whether the log as a source with the flagged data generated therefrom is a log representing a threat or not; and
outputting a determination result indicative of whether the log is a log representing a threat or not.

9. The non-transitory computer readable information recording medium according to claim 9, wherein
an email log likely to represent a threat is detected, and
flagged data is generated based on a flag condition for determining whether a predetermined character string is included in a sender of the email or not.
